(19) United States
(12) Patent Application Publication
(10) Pub. No.: US 2012/0121171 A1
(43) Pub. Date: May 17, 2012

(54) METHOD AND APPARATUS FOR DETERMINING A VALUE OF AN ATTRIBUTE TO BE ASSOCIATED WITH AN IMAGE

(75) Inventors: Marc Andre Peters, Eindhoven (NL); Pedro Fonseca, Eindhoven (NL)

(73) Assignee: KONINKLIJKE PHILIPS ELECTRONICS N.V., EINDHOVEN (NL)

(21) Appl. No.: 13/386,922

(22) PCT Filed: Jul. 20, 2010
(86) PCT No.: PCT/IB10/53308

§ 371 Date: Jan. 25, 2012

(30) Foreign Application Priority Data
Jul. 31, 2009 (EP) 09166918.4

(51) Int. Cl. G06K 9/00

(52) U.S. Cl. 382/162

(57) ABSTRACT

A method for determining a value of an attribute to be associated with an image, the method comprising the steps of: determining saturation of each of a plurality of pixels of an image; selecting a set of a plurality of pixels from the pixels of the image having a saturation above a predetermined level; determining a value of an attribute on the basis of the selected set of pixels; and associating the determined value of the attribute with the image.

### FIELD OF THE INVENTION

The present invention relates to a method and apparatus for determining a value of an attribute to be associated with an image. In particular it relates to a method and apparatus for determining an attribute value of colour of a light source when an image was captured or a dominant colour of an image to create appropriate ambient lighting during display of an image.

### BACKGROUND TO THE INVENTION

A sequence of still digital images is often used for presentations, or for atmospheric display. An example is a digital photo frame connected to an ambient light source (like a LivingColors lamp); where for each image the ambient light is automatically adjusted to match with the current image being displayed. The matching could be based on an attribute of an image such as for example the most dominant colour of an image, or the colour of the ambient lighting or light source reflected in the image which can result in ambient lighting during display that is appealing.

Estimating the light source from an image gives very interesting and natural results regarding the colour of the light entering the particular scene. It is a perfect colour to be used for atmosphere creation based on content that a viewer is watching. However, where professional photographers are well-trained to use lights and special effects that create superb results, the estimated colour of a light source from natural images taken by the average user will often result in white or “washed out” colours which correspond to the colour of natural sunlight. Although this is mathematically correct, it is not very attractive for the purpose of atmosphere creation; in fact, more interesting, non-white colours are preferred, keeping in mind that they should still look and feel natural.

### SUMMARY OF INVENTION

The present invention seeks to provide improved determination of a value of an attribute to be associated with an image to enhance display of the image.

This is achieved, according to one aspect of the present invention, by a method for determining a value of an attribute to be associated with an image, the method comprising the steps of: determining saturation of each of a plurality of pixels of an image; selecting a set of a plurality of pixels from the pixels of the image having a saturation above a predetermined level; determining a value of an attribute on the basis of the selected set of pixels; and associating the determined value of the attribute with the image.

This is also achieved, according to a second aspect of the present invention, by apparatus for determining a value of an attribute to be associated with an image, the apparatus comprising: determining means for determining saturation of each of a plurality of pixels of an image; selecting means for selecting a set of a plurality of pixels from the pixels of the image having a saturation above a predetermined level; determining means for determining a value of an attribute on the basis of the selected set of pixels; and associating means for associating the determined value of the attribute with the image.

Please note that the image according to the aspects above may refer to a whole image, parts of an image or a region of interest.

In this way, pixels having a low saturation are excluded from the computation of the attribute value. For example, the attribute may be colour and may be utilised to determine the most dominant colour of an image or alternatively the light source when the image was captured, for example the colour of the light source. These attribute values may be then used to provide corresponding ambient lighting to be used during display of the image and hence pixels with desaturated colours are excluded. This avoids the use of white or “washed out” colours in the ambient lighting which overall improves the ambient lighting for a particular image.

In an embodiment, the step of determining a value of an attribute on the basis of said selected set of pixels comprises the step of: carrying out analysis of attribute values of each of the selected set of pixels. For example, principal component analysis may be used for determining the light source. Alternatively, the selected pixels may be analysed to determine the most dominant colour by determining the colour having the highest percentage contribution.

In this way, an existing technique can be utilized to determine the value of an attribute.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for determining a value of an attribute to be associated with an image according to an embodiment of the present invention; and

FIG. 2 is a flowchart of a method of for determining a value of an attribute to be associated with an image according to an embodiment of the present invention.

### DETAILED DESCRIPTION OF EMBODIMENTS OF THE INVENTION

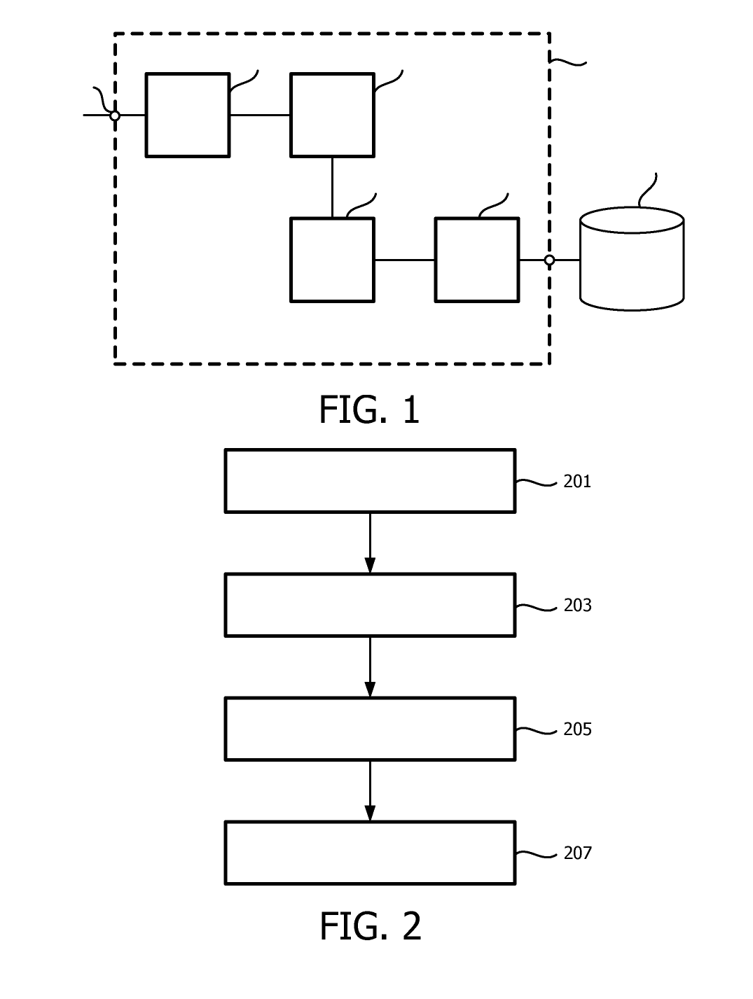

With reference to FIG. 1, the apparatus 100 comprises an input terminal 101 connected to the input of a first determining means 103. The output of the first determining means 103 is connected to the input of a selecting means 105. The output of the selecting means 105 is connected to the input of a second determining means 107. The output of the second determining means 107 is connected to the input of an associating means 109. The output of the associating means 109 is connected to an output terminal 111. The output terminal 111 of the apparatus 100 is connected to a storage device 113. The input terminal 101 of the apparatus 100 may also have access to the storage device 113 (not shown here).

Although the storage means 113 is illustrated here as external to the apparatus 100, in an alternative embodiment, the storage means 113 may be integral with the apparatus. The storage means 113 may be a memory device of a computer system, such as a ROM/RAM drive, CD, a memory device of a camera, digital photo frame or like device connected to the apparatus 100, or remote server. It may be accessed via a wired or wireless connection and/or accessed via a wider network such as the Internet. The storage means 113 stores a plurality of images. Images stored on a remote server, for example, may be uploaded and temporarily stored in a local storage means (not shown here) of the apparatus 100.

Operation of the apparatus of FIG. 1 will now be described with reference to FIG. 2.

An image is retrieved from the storage means 113 and input via the input terminal 101 into the first determining means 103. The saturation of each pixel of the retrieved image is determined, step 201, by the first determining means 103.

Next, in step 203, pixels having saturation above a predetermined threshold are selected by the selecting means 105. Note that, for a pixel in the RGB colour space, the saturation as defined by the HSV colour space is given by

$$saturation = \frac{Max ( R , G , B ) - Min ( R , G , B )}{Max ( R , G , B )}$$

if Max(R,G,B)>0, or saturation=0 otherwise.

Alternatively, the saturation may be determined in the HSL or HSB colour space or directly from the colour spaces such as YUV or YCbCr.

In the HSV color space saturation is in the interval [0,1], and an example of a threshold value is 0.2, so all the pixels with saturation below 0.2 are not taken into account for computing the light source or most dominant colour of the image. Alternatively, a threshold of 20% of the saturation range may be applied regardless of the way saturation is computed. For example, suppose that the saturation is computed in a different way and has a value between [a, b]. An appropriate threshold may be more generally defined as (b−a)*0.2+a.

These selected pixels are then processed by the second determining means 107, step 205, to determine the value of an attribute (colour) to be associated with the image. These may be based on the most dominant colour of the selected pixels or the light source that would have generated the colour of the selected pixels.

To determine the most dominant colour, for example, the selected pixels are analyzed to determine the colour having the highest percentage contribution. Alternatively, to determine the light source, the colour caused by reflection of the light source on the white surfaces is determined, step 203, by the selector 105.

In more detail, the light source entering a scene can be determined using a known technique, principal component analysis (PCA).

It is known that light entering an image will be reflected on the white parts of the image. All the pixels in the image will be coloured in the colour of the light source, according to the luminance.

Firstly, the selected pixels are transformed into a 3 dimensional cube in a RGB space. This is achieved by starting from the average values as a point of origin; the axes are transformed into 3 new axes in such a way that the first axis (the principal component) is responsible for most of the variation in the set of pixels. The principal axis can also be computed by least squares minimization.

The final step is to estimate the point on the principal axis that corresponds to the actual light source. This can be done by projecting the pixels on the principal axis and check where the contribution is significant (i.e. avoid taking a single pixel because it might be there because of encoding).

In an embodiment, if there is no light source available, the algorithm may yield one of the brighter dominant colours of the image. Also note that this algorithm can be applied for parts of an image as well to find light sources for a region of interest.

Since only pixels having saturation above a predetermined level are used, this guarantees that the result will be neither a white nor a “washed-out” colour, which will be therefore more appealing for the purpose of atmosphere creation. Further, since the algorithm yields one of the (brighter) dominant colours in case the light source cannot be detected, the resulting colour will never look unnatural.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for determining a value of an attribute to be associated with an image, the method comprising the steps of:
determining saturation of each of a plurality of pixels of an image;
selecting a set of a plurality of pixels from said pixels of said image having a saturation above a predetermined level;
determining a value of an attribute on the basis of said selected set of pixels; and
associating said determined value of said attribute with said image.

2. A method according to claim 1, wherein the step of determining a value of an attribute on the basis of said selected set of pixels comprises the step of:
carrying out analysis of attribute values of each of said selected set of pixels.

3. A method according to claim 1, wherein the attribute is colour.

4. A method according to claim 3, wherein said step of determining a value of an attribute on the basis of said selected set of pixels further comprises the step of:
determining the most dominant colour of an image.

5. A method according to claim 3, wherein said step of determining a value of an attribute on the basis of said selected set of pixels further comprises the step of:
determining the light source when the image was captured.

6. A computer program product comprising a plurality of program code portions for carrying out the method according to claim 1.

7. Apparatus for determining a value of an attribute to be associated with an image, the apparatus comprising:
determining means for determining saturation of each of a plurality of pixels of an image;
selecting means for selecting a set of a plurality of pixels from said pixels of said image having a saturation above a predetermined level;
determining means for determining a value of an attribute on the basis of said selected set of pixels; and
associating means for associating said determined value of said attribute with said image.
